(19) United States
(12) Patent Application Publication
(10) Pub. No.: US 2014/0073538 A1
(43) Pub. Date: Mar. 13, 2014

(54) Fluid Loss Control Composition and Method of Using the Same

(71) Applicants: Rajesh Kumar Saini, Cypress, TX (US); Feng Liang, Cypress, TX (US)

(72) Inventors: Rajesh Kumar Saini, Cypress, TX (US); Feng Liang, Cypress, TX (US)

(73) Assignee: Halliburton Energy Services, Inc., Houston, TX (US)

(21) Appl. No.: 13/611,187

(22) Filed: Sep. 12, 2012

(51) Int. Cl. C09K 8/00

(52) U.S. Cl. 507/215

(57) ABSTRACT

Fluid loss materials including carboxymethylcellulose and zirconium-based crosslinkers may be employed as fluid loss materials in methods of treating subterranean formations. One method includes providing a treatment fluid including carboxymethylcellulose (CMC) and a crosslinker including zirconium, wherein the carboxymethylcellulose has a degree of substitution in a range of from about 0.5 to about 2.5, wherein the crosslinker including zirconium includes one selected from the group consisting of ammonium zirconium fluoride, zirconium 2-ethylhexanoate, zirconium acetate, zirconium neodecanoate, zirconium acetylacetonate, tetrakis(triethanolamine) zirconate, zirconium carbonate, ammonium zirconium carbonate, zirconyl ammonium carbonate, zirconium complex of hydroxyethyl glycine, zirconium malonate, zirconium propionate, zirconium lactate, zirconium acetate lactate, and zirconium tartrate, and placing the treatment fluid in a subterranean formation, wherein the treatment fluid controls fluid loss in a permeable portion of the subterranean formation penetrated by a wellbore.

### BACKGROUND

The present invention relates to fluid loss materials useful for subterranean operations, and more particularly, fluid loss materials comprising carboxymethylcellulose and zirconium-based crosslinkers, and methods of use employing such fluid loss materials to treat subterranean formations.

Lost circulation frequently involves the loss of drilling, completion, or cementing fluids into formation voids during drilling, circulation, running casing, or cementing operations. Zones of high porosity and/or permeability, rubble zones, gravel and other natural voids may all cause fluid loss into the formation. In some circumstances, lost-circulation problems are caused in depleted zones where the formation pore pressure is lower than that of the upper portion of the formation. In such cases, increases in hydrostatic pressure may fracture weak formations and lead to lost circulation. Fluid loss to thief zones may also be problematic, for example, during cementing operations where water loss to such zones may result in the formation of a dehydrated cement bridge. The concomitant lowering of hydrostatic pressure below such a bridge may cause formation gases to bubble up through the cement resulting in channeling through the cement column and up to the surface of the formation. To prevent fluid loss in these various situations, a lost circulation material (LCM) is typically employed.

LCMs are diverse in nature and include, for example, various bridging agents in granular, fiber, or flake form, crosslinkable polymers, and swellable polymers. Some LCMs may be added directly to drilling fluids, cement slurries, or other treatment fluids. LCMs and chemical products specifically designed to treat fluid loss include, for example, cellulose, almond hulls, black walnut hulls, dried tumbleweed, kenaf, paper, asphalt and both coarse and fine rice. Another method involves pumping a powdered bentonite-diesel oil pill and chasing it with water. The pill forms a semi-solid mass that may stem severe fluid loss. Bentonite may also be mixed with polymers to form a pliable gel in the presence of water.

Among the various LCMs, cellulose-based LCMs may be particularly useful, at least in part, due to their potential low environmental impact. However, in order to realize the benefits of using cellulose-based crosslinked materials in fluid loss applications, some cellulose-based materials may require derivatization prior to use, adding time and cost of additional manufacturing steps. Some cellulosed-based materials may also suffer from premature or overly rapid crosslinking, for example in the presence of divalent and polyvalent ions, resulting in a short window of opportunity to conveniently pump the material to its intended subterranean target. Still other issues arise from lack of compatibility with brines employed to tune the density of the fluid.

Moreover, once a crosslinked cellulose-based LCM is formed, it is not always as stable as it should be under various stresses such as changes in downhole temperature, pH, and the like. At the opposite end of the spectrum, some crosslinked cellulose-based LCMs are so stable that gel breakdown and cleanup, when fluid loss control is no longer required, may be problematic. Thus, there is a continuing challenge to find compositions that strike the balance between gel stability for fluid loss control and subsequent gel breakdown in cleanup.

### SUMMARY OF THE INVENTION

The present invention relates to fluid loss materials useful for subterranean operations, and more particularly, fluid loss materials comprising carboxymethylcellulose and zirconium-based crosslinkers, and methods of use employing such fluid loss materials to treat subterranean formations.

In some embodiments, the present invention provides a method comprising providing a treatment fluid comprising carboxymethylcellulose (CMC) and a crosslinker comprising zirconium, wherein the carboxymethylcellulose has a degree of substitution in a range of from about 0.5 to about 2.5, wherein the crosslinker comprising zirconium comprises one selected from the group consisting of ammonium zirconium fluoride, zirconium 2-ethylhexanoate, zirconium acetate, zirconium neodecanoate, zirconium acetylacetonate, tetrakis(triethanolamine) zirconate, zirconium carbonate, ammonium zirconium carbonate, zirconyl ammonium carbonate, zirconium complex of hydroxyethyl glycine, zirconium malonate, zirconium propionate, zirconium lactate, zirconium acetate lactate, and zirconium tartrate, and placing the treatment fluid in a subterranean formation, wherein the treatment fluid controls fluid loss in a permeable portion of the subterranean formation penetrated by a wellbore.

In other embodiments, the present invention provides a method comprising providing a treatment fluid comprising a crosslinked gel, the crosslinked gel comprising carboxymethylcellulose and a crosslinker comprising zirconium, wherein the crosslinker comprising zirconium comprises one selected from the group consisting of ammonium zirconium fluoride, zirconium 2-ethylhexanoate, zirconium acetate, zirconium neodecanoate, zirconium acetylacetonate, tetrakis(triethanolamine) zirconate, zirconium carbonate, ammonium zirconium carbonate, zirconyl ammonium carbonate, zirconium complex of hydroxyethyl glycine, zirconium malonate, zirconium propionate, zirconium lactate, zirconium acetate lactate, and zirconium tartrate, and shearing the crosslinked gel to provide a plurality of gel particles having an average diameter in the range of from about 0.5 mm to about 50 mm, placing the plurality of gel particles in an aqueous fluid having a density similar to the density of the gel particles whereby a suspension of the plurality of gel particles is produced, and placing the suspension in a permeable portion of a wellbore penetrating a subterranean formation to control fluid loss.

In still other embodiments, the present invention provides a method comprising providing a treatment fluid comprising a crosslinked gel, the crosslinked gel comprising carboxymethylcellulose and a crosslinker comprising zirconium, wherein the carboxymethylcellulose has a degree of substitution in a range of from about 0.5 to about 2.5, shearing the crosslinked gel to provide a plurality of gel particles having an average diameter in the range of from about 0.5 mm to about 50 mm, placing the plurality of gel particles in an aqueous fluid having a density similar to the density of the gel particles whereby a suspension of the plurality of gel particles is produced, and placing the suspension in a permeable portion of a wellbore penetrating a subterranean formation to control fluid loss.

The features and advantages of the present invention will be readily apparent to those skilled in the art upon a reading of the description of the preferred embodiments that follows.

### BRIEF DESCRIPTION OF THE DRAWINGS

The following figures are included to illustrate certain aspects of the present invention, and should not be viewed as exclusive embodiments. The subject matter disclosed is capable of considerable modifications, alterations, combinations, and equivalents in form and function, as will occur to those skilled in the art and having the benefit of this disclosure.

FIG. 1 is a plot showing fluid loss as a function of time in an exemplary zirconium crosslinked carboxymethylcellulose, in accordance with embodiments of the invention.

### DETAILED DESCRIPTION

The present invention relates to fluid loss materials useful for subterranean operations, and more particularly, fluid loss materials comprising carboxymethylcellulose and zirconium-based crosslinkers, and methods of use employing such fluid loss materials to treat subterranean formations.

Carboxymethylcellulose (CMC) is a cellulose ether, generally produced by reacting alkali cellulose with sodium monochloroacetate under rigidly controlled conditions. In the structure of a cellulose molecule, each glucose unit in the cellulose chain has three hydroxyl groups, each of which is capable of hydrogen bonding to an adjacent molecule. Because of the abundance of hydroxyl groups, and their ability to hydrogen bond to a neighboring molecule, the chains tend to be bound tightly together. Regardless of temperature, water molecules generally cannot force their way in between the chains to hydrate them, thus rendering cellulose mostly water insoluble. The manufacturing of CMC involves two steps. In the first step, cellulose is suspended in alkali to open the bound cellulose chains, allowing water to enter. Once this happens, the cellulose is then reacted with sodium monochloroacetate to yield sodium carboxymethyl cellulose. Since one glucose unit contains three hydroxyl groups, a degree of substitution (D.S.) of 3.0 is the theoretical maximum one could attain. This process tends to compromise the crystalline structure of cellulose polymer chains, allowing water to slip in between the CMC molecules and hydrate them thus conferring CMC with water solubility.

Of the many advantages of the compositions and related methods of the present invention, one is that treatment fluids of the present invention may employ carboxymethylcellulose (CMC) without further chemical modification, unlike other cellulosic materials. Such chemical modifications generally necessitate batch quality control testing of the modified cellulosic materials, resulting in increased time and cost of operations.

In preparation of the CMC-based fluid loss materials disclosed herein, the CMC crosslinking step may be carried out at a relatively low pH, such as at about pH 6.0 by adding zirconium (Zr) or aluminum (Al) crosslinkers. Other cellulose-based materials may be crosslinked only at high pH, making them incompatible with salts such as ZnBr₂ and NaBr, which may be desirably used in brines to weight the treatment fluid. For example, some derivatized cellulosic materials only crosslink when the pH is raised to above about 10.5. At such a pH, copious precipitation may occur in ZnBr₂ brines. Additionally, CMC-based fluid loss materials provided herein may tolerate calcium ions better than other cellulosic-based systems. Finally with respect to preparation, there may be no need to hydrate the CMC at low pH, in contrast to other cellulosic-based fluid loss materials where hydration may be required at a pH less than about 0.1.

In particular, the present invention provides zirconium-based crosslinkers combined with CMC, wherein crosslinking may be readily delayed for easy pumping. Further, with respect to the particular combination of zirconium-crosslinked CMC-based fluid loss materials, such materials may exhibit improved gel stability even relative to other metal-CMC crosslinked gel systems. This observation is shown in the Examples below, demonstrating that zirconium-based crosslinking provides a more stable gel than aluminum-based crosslinked gels.

Further advantageously, the CMC-based fluid loss materials may be used in conjunction with internal and/or external breakers to break up the fluid loss material when it is no longer needed. After breakage the CMC may leave considerably less insoluble residue that may adversely plug the formation. CMC-based fluid loss materials may provide much cleaner and environmentally friendly systems in comparison to other cellulosic-based fluid loss materials. For example, some cellulosic-based LCMs contain phosphate and are based on liquid gel concentrates (LGCs). LGCs typically introduce oil to the system, which may not be environmentally advantageous. Given the guidance provided herein, other advantages will be apparent to the skilled artisan having the benefit of this disclosure.

In some embodiments, the present invention provides methods comprising providing treatment fluids comprising carboxymethylcellulose (CMC) and crosslinkers comprising zirconium, wherein carboxymethylcellulose has a degree of substitution in a range of from about 0.5 to about 2.5, wherein the crosslinkers comprising zirconium comprise one selected from the group consisting of ammonium zirconium fluoride, zirconium 2-ethylhexanoate, zirconium acetate, zirconium neodecanoate, zirconium acetylacetonate, tetrakis(triethanolamine) zirconate, zirconium carbonate, ammonium zirconium carbonate, zirconyl ammonium carbonate, zirconium complex of hydroxyethyl glycine, zirconium malonate, zirconium propionate, zirconium lactate, zirconium acetate lactate, and zirconium tartrate, and the method comprising placing the treatment fluid in a subterranean formation, wherein the treatment fluids control fluid loss in permeable portions of subterranean formations penetrated by wellbores. In some embodiments, a zirconium acetate lactate crosslinker may be preferred.

In some embodiments, treatment fluids comprising carboxymethylcellulose (CMC), may employ CMC having a degree of substitution (D.S) in a range of from about 0.5 to about 2.5. CMC may be initially provided, for example, as sodium carboxymethylcellulose, in some embodiments. In some embodiments, the degree of substitution may be selected to confer water solubility of the CMC before and after crosslinking. “Water solubility,” as used herein, means that the CMC leaves little insoluble residue, which may adversely affect the formation and/or impede gelation. In some embodiments, water-soluble CMC is at least 90% water soluble. In other embodiments, water-soluble CMC is at least 95% water soluble. In still further embodiments, water-soluble CMC is at least 99% water soluble. Optimum water solubility and other desirable physical properties of CMC may be obtained at a much lower degree of substitution than 3. The degree of substitution and the degree of polymerization may affect its water solubility and their solution characteristics. As molecular weight increases, the viscosity of CMC solutions may increase rapidly. CMC may be readily water-soluble when its D.S is more than about 0.4 and would therefore be suitable for use in treatment fluids of the present invention. CMC useful in the methods of the present invention may also have D.S. greater than 2.5, including for example, 2.6, 2.7, 2.8, and 2.9. A higher degree of substitution tends to provide improved compatibility with other soluble components such as salts and nonsolvents. The exact D.S. or range of D.S. may be selected for gel formation performance with respect to the time to crosslink as well as gel stability, as would be recognized by those skilled in the art. It should be noted that when “about” is provided at the beginning of a numerical list, “about” modifies each number of the numerical list. In some embodiments, the CMC useful in the methods of the present invention may also have D.S ranging from a lower limit of about 0.4, 0.5, 0.6, 0.7, 0.8, 0.9, or 1 to an upper limit of about 3, 2.9, 2.8, 2.7, 2.6, 2.5, 2.4, 2.3, 2.2, 2.1, 2, 1.9, 1.8, 1.7, 1.6, 1.5, 1.4, 1.3, 1.2, 1.1, 1, 0.9, 0.8, or 0.7; wherein the percentage of consolidating agent may range from any lower limit to any upper limit and encompass any subset between the upper and lower limits. To the extent any of the lower limits listed above are greater than any of the listed upper limits, one skilled in the art will recognize that the selected subset will require the selection of an upper limit in excess of the selected lower limit. In some embodiments, the D.S. may be in a range from about 0.5 to about 1.0.

CMC is manufactured in a wide range of viscosities, any of which may be employed in methods of the present invention. High-viscosity types are prepared from high viscosity cotton liners. Medium-viscosity types are prepared from wood pulp of specified viscosity. Low viscosity types are prepared by aging the shredded alkali cellulose and by using chemical oxidants. The foregoing methods of regulating the viscosity are based on controlling the DP. It is also possible to attain high viscosity by decreasing the solubility so that the product is highly swollen but not completely dispersed. In some embodiments, this may be accomplished by decreasing the uniformity of the reaction and lowering the D.S. For example, CMC with D.S. of 1.2 does not have solution viscosities as high as products of D.S. 0.7 prepared in substantially the same way. However, the solutions of the higher-substituted CMC are much smoother. The degree of neutralization of carboxymethyl groups also impacts viscosity. In solution, the degree of neutralization is controlled by the pH. At the end of the carboxymethylation during CMC preparation, the reaction mixture contains a slight excess of sodium hydroxide, which is usually neutralized. Although the neutral point of CMC is about pH 8.25, the pH may be adjusted to about 7-7.5. If the pH to which the CMC is neutralized to 6.0 or less, the dried product may not have good solubility in water; solutions may be hazy and contain insoluble gel particles. If the pH is 4 or below, the dried product tends to be insoluble in water.

In some embodiments, methods of the invention may employ treatment fluids comprising zirconium-crosslinked CMC. In some such embodiments, the crosslinkers comprising zirconium comprise one selected from the group consisting of ammonium zirconium fluoride, zirconium 2-ethylhexanoate, zirconium acetate, zirconium neodecanoate, zirconium acetylacetonate, tetrakis(triethanolamine) zirconate, zirconium carbonate, ammonium zirconium carbonate, zirconyl ammonium carbonate, zirconium complex of hydroxyethyl glycine, zirconium malonate, zirconium propionate, zirconium lactate, zirconium acetate lactate, and zirconium tartrate. In some embodiments, the zirconium salt may be zirconium acetate lactate. In some embodiments, a combination of the aforementioned zirconium salts may be employed. In some embodiments, zirconium salts may be selected for counterion affinity as a ligand to the zirconium metal to modulate the rate of gelation. In some embodiments, zirconium salts may be selected for counterion affinity as a ligand to effect reversible crosslinking of the CMC.

In some embodiments, methods of the invention may employ treatment fluids having a pH in a range of from about 4 to about 7. In some embodiments, the treatment fluids may have a pH of about 4, about 5, about 6, or about 7, including any value in between. Any pH from about 4 to about 7 may be operational for the purpose of forming gels for fluid loss control applications. As described herein above, such a range of pH beneficially allows for compatibility with a wide array of treatment fluid brines.

In some embodiments, methods of the invention may employ treatment fluids weighted with brine solutions. In some such embodiments, methods of the invention may employ brine solutions comprising one selected from the group consisting of sodium chloride, potassium chloride, ammonium chloride, sodium bromide, potassium bromide, zinc bromide, sodium formate, potassium formate, cerium formate, calcium chloride, and combinations thereof.

In some embodiments, methods of the invention may employ treatment fluids having a density in a range of from a lower limit of about 8.3 lb/gal, 8.4 lb/gal, 8.5 lb/gal, 8.7 lb/gal, 9.0 lb/gal, 9.5 lb/gal, or 10.0 lb/gal to an upper limit of about 16 lb/gal, 15.5 lb/gal, 15 lb/gal, 14.5 lb/gal, 14.0 lb/gal, 13.5 lb/gal, 13 lb/gal, 12.5 lb/gal, 12 lb/gal, 11.5 lb/gal. To the extent any of the lower limits listed above are greater than any of the listed upper limits, one skilled in the art will recognize that the selected subset will require the selection of an upper limit in excess of the selected lower limit. The exact choice of density will be apparent to the skilled artisan in consideration of the exact conditions of the subterranean operation being performed and the downhole conditions such as temperature, pressure, and formation composition.

In accordance with various methods of the invention, the resultant zirconium-crosslinked CMC may provide a gel product useful as a fluid loss material. In some embodiments, gel formation may be performed prior to introduction into the formation. In other embodiments, gel formation may be performed in situ downhole. In some embodiments, the gel may be formed upon adjustment of pH, temperature, or a combination of both. In some embodiments, the gel may be formed as a pill, as known in the art.

In some embodiments, the present invention provides methods comprising providing treatment fluids comprising crosslinked gels, the crosslinked gels comprising carboxymethylcellulose and crosslinkers comprising zirconium, wherein the crosslinkers comprising zirconium comprise one selected from the group consisting of ammonium zirconium fluoride, zirconium 2-ethylhexanoate, zirconium acetate, zirconium neodecanoate, zirconium acetylacetonate, tetrakis(triethanolamine) zirconate, zirconium carbonate, ammonium zirconium carbonate, zirconyl ammonium carbonate, zirconium complex of hydroxyethyl glycine, zirconium malonate, zirconium propionate, zirconium lactate, zirconium acetate lactate, and zirconium tartrate, and the methods comprising shearing the crosslinked gels to provide a plurality of gel particles having an average diameter anywhere in the range of from about 0.5 mm to about 50 mm, placing the plurality of gel particles in aqueous fluids having a density similar to the density of the gel particles whereby suspensions of the plurality of gel particles are produced, and placing the suspensions in permeable portions of wellbores penetrating subterranean formations to control fluid loss. In some such embodiments, the plurality of gel particles may be pre-formed prior to placement in the subterranean formation.

In some such embodiments, the carboxymethylcellulose may have a degree of substitution as described above (ranging from about 0.4 to about 3, preferably from about 0.5 to about 2.5). In some such embodiments, the treatment fluids may further comprise brine solutions, the brine solutions comprising one selected from the group consisting of sodium chloride, potassium chloride, ammonium chloride, sodium bromide, potassium bromide, zinc bromide, sodium formate, potassium formate, cerium formate, calcium chloride, and combinations thereof. In some such embodiments, the treatment fluids may have a density in a range as described above (ranging from about 8.3 lb/gal to about 16.0 lb/gal, preferably from about 8.3 lb/gal to about 14 lb/gal). In some such embodiments, the treatment fluids may have a pH in a range of from about 4 to about 7.

In some embodiments, the present invention provides methods comprising providing treatment fluids comprising crosslinked gels, the crosslinked gels comprising carboxymethylcellulose and crosslinkers comprising zirconium, wherein the carboxymethylcellulose has a degree of substitution in a range of from about as described above (ranging from about 0.4 to about 3, preferably from about 0.5 to about 2.5), the methods further comprising shearing the crosslinked gels to provide a plurality of gel particles having an average diameter in the range of from about 0.5 mm to about 50 mm, placing the plurality of gel particles in aqueous fluids having a density similar to the density of the gel particles whereby suspensions of the plurality of gel particles are produced, and placing the suspensions in permeable portions of wellbores penetrating subterranean formations to control fluid loss.

In some such embodiments, the crosslinkers comprising zirconium comprise one selected from the group consisting of ammonium zirconium fluoride, zirconium 2-ethylhexanoate, zirconium acetate, zirconium neodecanoate, zirconium acetylacetonate, tetrakis(triethanolamine) zirconate, zirconium carbonate, ammonium zirconium carbonate, zirconyl ammonium carbonate, zirconium complex of hydroxyethyl glycine, zirconium malonate, zirconium propionate, zirconium lactate, zirconium acetate lactate, and zirconium tartrate. In some embodiments, the zirconium crosslinker may be zirconium acetate lactate.

In some such embodiments, the treatment fluids may further comprise brine solutions. In some such embodiments, the brine solutions comprise one selected from the group consisting of sodium chloride, potassium chloride, ammonium chloride, sodium bromide, potassium bromide, zinc bromide, sodium formate, potassium formate, cerium formate, calcium chloride, and combinations thereof. In some such embodiments, the treatment fluids may have a density in a range as described above (ranging from about 8.3 lb/gal to about 16.0 lb/gal, preferably from about 8.3 lb/gal to about 14 lb/gal). In some such embodiments, the treatment fluids may have a pH in a range of from about 4 to about 7.

Methods of the invention employ treatment fluids that may be used as part of any subterranean operation. Such operations include, but are not limited to, drilling operations, lost circulation operations, stimulation operations, sand control operations, completion operations, acidizing operations, scale inhibiting operations, water-blocking operations, clay stabilizer operations, fracturing operations, frac-packing operations, gravel packing operations, wellbore strengthening operations, enhanced oil recovery operations, fluid diverting operations, and sag control operations. The methods and compositions of the present invention may be used in full-scale operations or pills. As used herein, a “pill” is a type of relatively small volume of specially prepared treatment fluid placed or circulated in the wellbore. In some embodiments, treatment fluids comprising the zirconium-crosslinked CMC fluid loss materials employed in methods of the invention may perform the function of controlling flow of formation fluids, controlling the treatment fluid itself, controlling other treatment fluids, and combinations thereof.

Treatment fluids of the invention may be aqueous-based, oil-based, or combinations thereof. Thus, suitable base fluids in treatment fluids of the invention, for use in conjunction with various methods may include, but are not limited to, oil-based fluids, aqueous-based fluids, aqueous-miscible fluids, water-in-oil emulsions, or oil-in-water emulsions.

Aqueous base fluids suitable for use in the treatment fluids of the present invention may comprise fresh water, saltwater (e.g., water containing one or more salts dissolved therein), brine (e.g., saturated salt water), seawater, or combinations thereof. Generally, the water may be from any source, provided that it does not contain components that might adversely affect the stability and/or performance of the treatment fluids of the present invention. In certain embodiments, the density of the aqueous base fluid can be adjusted, among other purposes, to provide additional particulate transport and suspension in the treatment fluids used in the methods of the present invention. In certain embodiments, the pH of the aqueous base fluid may be adjusted (e.g., by a buffer or other pH adjusting agent), among other purposes, to activate zirconium cross-linking and/or to reduce the viscosity of the treatment fluid (e.g., activate a breaker, deactivate a crosslinking agent) and/or to control the rate of degradation of the zirconium-crosslinked CMC itself. In these embodiments, the pH may be adjusted to a specific level, which may depend on, among other factors, the types of gelling agents, acids, and other additives included in the treatment fluid. One of ordinary skill in the art, with the benefit of this disclosure, will recognize when such density and/or pH adjustments are appropriate.

Suitable oil-based fluids may include alkanes, olefins, aromatic organic compounds, cyclic alkanes, paraffins, diesel fluids, mineral oils, desulfurized hydrogenated kerosenes, and any combination thereof. Suitable aqueous-based fluids may include fresh water, saltwater (e.g., water containing one or more salts dissolved therein), brine (e.g., saturated salt water), seawater, and any combination thereof. Suitable aqueous-miscible fluids may include, but not be limited to, alcohols, e.g., methanol, ethanol, n-propanol, isopropanol, n-butanol, sec-butanol, isobutanol, and t-butanol; glycerins; glycols, e.g., polyglycols, propylene glycol, and ethylene glycol; polyglycol amines; polyols; any derivative thereof; any in combination with salts, e.g., sodium chloride, calcium chloride, calcium bromide, zinc bromide, potassium carbonate, sodium formate, potassium formate, cesium formate, sodium acetate, potassium acetate, calcium acetate, ammonium acetate, ammonium chloride, ammonium bromide, sodium nitrate, potassium nitrate, ammonium nitrate, ammonium sulfate, calcium nitrate, sodium carbonate, and potassium carbonate; any in combination with an aqueous-based fluid, and any combination thereof. Suitable water-in-oil emulsions, also known as invert emulsions, may have an oil-to-water ratio from a lower limit of greater than about 50:50, 55:45, 60:40, 65:35, 70:30, 75:25, or 80:20 to an upper limit of less than about 100:0, 95:5, 90:10, 85:15, 80:20, 75:25, 70:30, or 65:35 by volume in the base treatment fluid, where the amount may range from any lower limit to any upper limit and encompass any subset therebetween. Examples of suitable invert emulsions include those disclosed in U.S. Pat. Nos. 5,905,061; 5,977,031; and 6,828,279, each of which are incorporated herein by reference. It should be noted that for water-in-oil and oil-in-water emulsions, any mixture of the above may be used including the water being and/or comprising an aqueous-miscible fluid.

Examples of suitable continuous mediums may include, but are not necessarily limited to, aqueous-based fluids, alcohols, glycerin, glycols, polyglycol amines, polyols, and any derivative thereof. Additionally, in some embodiments, the continuous medium may comprise a fluid selected from the group consisting of methanol, ethanol, n-propanol, isopropanol, n-butanol, sec-butanol, isobutanol, t-butanol, a mixture of methanol, ethanol, n-propanol, isopropanol, n-butanol, sec-butanol, isobutanol, or t-butanol and water, a mixture of ammonium sulfate, sodium sulfate, or potassium sulfate and water, a mixture of sodium chloride, potassium chloride, or calcium chloride and water, and combinations thereof. Optionally, the continuous medium comprises a fluid selected from the group consisting of ethanol, a mixture of t-butanol and water, and a mixture of ammonium sulfate and water. Mixtures of these may be suitable as well. Examples of suitable aqueous-based fluids may include, but are not necessarily limited to, fresh water, sea water, salt water, and brines (e.g., saturated salt waters). Examples of suitable brines may include, but are not necessarily limited to, heavy brines, monovalent brines, divalent brines, and trivalent brines that comprise soluble salts like sodium chloride, calcium chloride, calcium bromide, zinc bromide, potassium carbonate, sodium formate, potassium formate, cesium formate, sodium acetate, potassium acetate, calcium acetate, ammonium acetate, ammonium chloride, ammonium bromide, sodium nitrate, potassium nitrate, ammonium nitrate, ammonium sulfate, calcium nitrate, sodium carbonate, potassium carbonate, any combination thereof, and any derivative thereof. Examples of suitable alcohols may include, but are not necessarily limited to, methanol, ethanol, propanol, iso-propanol, butanol, tert-butanol, and the like. Examples of suitable glycols may include, but are not necessarily limited to, polyglycols, propylene glycol, ethylene glycol, and the like.

In some embodiments, the treatment fluids for use in conjunction with the present invention may be foamed. In some embodiments, treatment fluids for use in conjunction with the present invention may comprise an aqueous base fluid, a gas, and a foaming agent.

Suitable gases for use in conjunction with the present invention may include, but are not limited to, nitrogen, carbon dioxide, air, methane, helium, argon, and any combination thereof. One skilled in the art, with the benefit of this disclosure, should understand the benefit of each gas. By way of nonlimiting example, carbon dioxide foams may have deeper well capability than nitrogen foams because carbon dioxide emulsions have greater density than nitrogen gas foams so that the surface pumping pressure required to reach a corresponding depth is lower with carbon dioxide than with nitrogen. Moreover, the higher density may impart greater proppant transport capability, up to about 12 lbs. of proppant per gallon of fracture fluid.

In some embodiments, the quality of the foamed treatment fluid downhole may range from a lower limit of about 5%, 10%, 25%, 40%, 50%, 60%, or 70% gas volume to an upper limit of about 99%, 95%, 90%, 80%, 75%, 60%, or 50% gas volume, and wherein the quality of the foamed treatment fluid may range from any lower limit to any upper limit and encompass any subset in between. Most preferably, the foamed treatment fluid may have a foam quality from about 85% to about 99%, or about 95% to about 98%.

Suitable foaming agents for use in conjunction with the present invention may include, but are not limited to, cationic foaming agents, anionic foaming agents, amphoteric, zwitterionic foaming agents, nonionic foaming agents, or any combination thereof. Nonlimiting examples of suitable foaming agents may include, but are not limited to, surfactants like betaines, sulfated or sulfonated alkoxylates, alkyl quarternary amines, alkoxylated linear alcohols, alkyl sulfonates, alkyl aryl sulfonates, C10-C20 alkyldiphenyl ether sulfonates, polyethylene glycols, ethers of alkylated phenol, sodium dodecylsulfate, alpha olefin sulfonates such as sodium dodecane sulfonate, trimethyl hexadecyl ammonium bromide, and the like, any derivative thereof, or any combination thereof. Foaming agents may be included in foamed treatment fluids at concentrations ranging typically from about 0.05% to about 2% of the liquid component by weight (e.g., from about 0.5 to about 20 gallons per 1000 gallons of liquid).

A suitable oleaginous continuous phase for use in the present invention includes any oleaginous continuous phase fluid suitable for use in subterranean operations. By way of nonlimiting example, an oleaginous continuous phase may include an alkane, an olefin, an aromatic organic compound, a cyclic alkane, a paraffin, a diesel fluid, a mineral oil, a desulfurized hydrogenated kerosene, and any combination thereof. In some embodiments, the base treatment fluid may include an invert emulsion with an oleaginous continuous phase and an aqueous discontinuous phase. Suitable invert emulsions may have an oil-to-water ratio from a lower limit of greater than about 50:50, 55:45, 60:40, 65:35, 70:30, 75:25, or 80:20 to an upper limit of less than about 100:0, 95:5, 90:10, 85:15, 80:20, 75:25, 70:30, or 65:35 by volume in the base treatment fluid, where the amount may range from any lower limit to any upper limit and encompass any subset there between.

Treatment fluids of the invention may further comprise weighting agents, viscosifiers, emulsifiers, proppants, pH modifying agents, cementing compositions, lost circulation materials, corrosion inhibitors, other subterranean treatment fluid additives, and the like, depending on the function of the treatment fluid.

Depending on the use of the treatment fluid, in some embodiments, other additives may optionally be included in the treatment fluids of the present invention. Examples of such additives may include, but are not limited to, salts, pH control additives, surfactants, breakers, biocides, fluid loss control agents, stabilizers, chelating agents, scale inhibitors, gases, mutual solvents, particulates, corrosion inhibitors, oxidizers, reducers, and any combination thereof. A person of ordinary skill in the art, with the benefit of this disclosure, will recognize when such optional additives should be included in a treatment fluid used in the present invention, as well as the appropriate amounts of those additives to include.

The treatment fluids of the present invention also may comprise breakers capable of reducing the viscosity of the treatment fluid at a desired time. Examples of such suitable breakers for treatment fluids of the present invention include, but are not limited to, sodium chlorites, hypochlorites, perborate, persulfates, peroxides, including organic peroxides. Other suitable breakers include, but are not limited to, suitable acids and peroxide breakers, delinkers, as well as enzymes that may be effective in breaking fluid loss gels in treatment fluids of the invention. In some embodiments, the breaker may be a compliant breaker such as citric acid, other acids or chelating molecules found in 21 CFR §§170-199 (e.g. tetrasodium EDTA 175.300), oxidizers found in 21 CFR §§170-199 (e.g. ammonium persulfate 175.150), enzymes found within 21 CFR §§170-199 (e.g. cellulose enzymes 173.120). A breaker may be included in a treatment fluid of the present invention in an amount and form sufficient to achieve the desired viscosity reduction of the gel at a desired time. The breaker may be formulated to provide a delayed break, if desired. For example, a suitable breaker may be encapsulated if desired. Suitable encapsulation methods are known to those skilled in the art. One suitable encapsulation method that may be used involves coating the chosen breakers with a material that will degrade when downhole so as to release the breaker when desired. Resins that may be suitable include, but are not limited to, polymeric materials that will degrade when downhole. The terms “degrade,” “degradation,” or “degradable” refer to both the two relatively extreme cases of degradation that the degradable material may undergo, i.e., heterogeneous (or bulk erosion) and homogeneous (or surface erosion), and any stage of degradation in between these two. This degradation can be a result of, among other things, a chemical or thermal reaction or a reaction induced by radiation.

In certain embodiments of the present invention, the breakers may be encapsulated by synthetic and natural waxes. Waxes having different melting points may be used in order to control the delay of breaking based on the temperature of a specific subterranean operation. In an embodiment, the encapsulation of the breaker is performed by mixing the breaker and wax above the melting temperature for the specific wax and then extruding the composition to form small particles of the encapsulated material. The resulting product may be annealed by briefly heating the product to the point of the coating to seal cracks in the coating, thus preventing premature release. The encapsulation may also be achieved by melt spraying the wax on the breaker (e.g. citric acid) particles or by any other technique known by a person of ordinary skill in the art. If used, a breaker should be included in a treatment fluid of the present invention in an amount sufficient to facilitate the desired reduction in viscosity in a treatment fluid. For instance, peroxide concentrations that may be used vary from about 0.1 to about 30 gallons of peroxide per 1000 gallons of the treatment fluid.

Other suitable breakers include compliant breakers such as ethyl formate, propyl formate, butyl formate, amyl formate, anisyl formate, methyl acetate, propyl acetate, triacetin, butyl propionate, isoamyl propionate, ethyl lactate, methyl butyrate, ethyl isobutyrate, butyl isobutyrate, diethyl malonate, butyl ethyl malonate, dimethyl succinate, diethyl succinate, diethyl malate, diethyl tartrate, dimethyl tartrate, triethyl citrate, and any combination thereof.

Optionally, a treatment fluid of the present invention may comprise an activator or a retarder to, among other things, optimize the break rate provided by the breaker. Any known activator or retarder that is compatible with the particular breaker used is suitable for use in the present invention. Examples of such suitable activators include, but are not limited to, acid generating materials, chelated iron, copper, cobalt, and reducing sugars. Examples of suitable retarders include sodium thiosulfate, methanol, and diethylene triamine. In some embodiments, the sodium thiosulfate may be used in a range of from about 1 to about 100 lbs/Mgal of treatment fluid. A preferred range may be from about 5 to about 20 lbs/Mgal. An artisan of ordinary skill with the benefit of this disclosure will be able to identify a suitable activator or retarder and the proper concentration of such activator or retarder for a given application.

The treatment fluids of the present invention may comprise particulates, such as proppant particulates or gravel particulates. Such particulates may be included in the treatment fluids of the present invention, for example, when a gravel pack is to be formed in at least a portion of the well bore or a proppant pack is to be formed in one or more fractures in the subterranean formation. Particulates suitable for use in the present invention may comprise any material suitable for use in subterranean operations. Suitable materials for these particulates may include, but are not limited to, sand, bauxite, ceramic materials, glass materials, polymer materials, polytetrafluoroethylene materials, nut shell pieces, cured resinous particulates comprising nut shell pieces, seed shell pieces, cured resinous particulates comprising seed shell pieces, fruit pit pieces, cured resinous particulates comprising fruit pit pieces, wood, composite particulates, and combinations thereof. Suitable composite particulates may comprise a binder and a filler material wherein suitable filler materials include silica, alumina, fumed carbon, carbon black, graphite, mica, titanium dioxide, meta-silicate, calcium silicate, kaolin, talc, zirconia, boron, fly ash, hollow glass microspheres, solid glass, and combinations thereof. The mean particulate size generally may range from about 2 mesh to about 400 mesh on the U.S. Sieve Series; however, in certain circumstances, other mean particulate sizes may be desired and will be entirely suitable for practice of the present invention. In particular embodiments, preferred mean particulate size distribution ranges are one or more of 6/12, 8/16, 12/20, 16/30, 20/40, 30/50, 40/60, 40/70, or 50/70 mesh. It should be understood that the term “particulate,” as used in this disclosure, includes all known shapes of materials, including substantially spherical materials, fibrous materials, polygonal materials (such as cubic materials), and mixtures thereof. Moreover, fibrous materials, that may or may not be used to bear the pressure of a closed fracture, may be included in certain embodiments of the present invention. In certain embodiments, the particulates included in the treatment fluids of the present invention may be coated with any suitable resin or tackifying agent known to those of ordinary skill in the art. In certain embodiments, the particulates may be present in the treatment fluids of the present invention in an amount in the range of from about 0.5 pounds per gallon (“ppg”) to about 30 ppg by volume of the treatment fluid.

A biocide may be included to the treatment fluids of the present invention to reduce bioburden of the fluid to avoid introducing an undesirable level of bacteria into the subterranean formation. Suitable examples of biocides may include both oxidizing biocides and nonoxidizing biocides. Examples of oxidizing biocides include, but are not limited to, sodium hypochlorite, hypochlorous acid, chlorine, bromine, chlorine dioxide, and hydrogen peroxide. Examples of nonoxidizing biocides include, but are not limited to, aldehydes, quaternary amines, isothiazolines, carbamates, phosphonium quaternary compounds, and halogenated compounds. Factors that determine what biocide will be used in a particular application may include, but are not limited to, cost, performance, compatibility with other components of the treatment fluid, kill time, and environmental compatibility. One skilled in the art with the benefit of this disclosure will be able to choose a suitable biocide for a particular application.

In some embodiments, UV radiation may be used to reduce the bioburden of a fluid in place of chemical biocides or used in conjunction with chemical biocides. One method of using UV light to reduce bioburden suitable for use in the present invention involves adding a photoinitiator to the treatment fluid and then exposing the treatment fluid to a UV light source. Such photoinitiators may absorb the UV light and undergo a reaction to produce a reactive species of free radicals that may in turn trigger or catalyze desired chemical reactions. Suitable organic photoinitiators for use in the present invention may include, but are not limited to, acetophenone, propiophenone, benzophenone, xanthone, thioxanthone, fluorenone, benzaldehyde, anthraquinone, carbazole, thioindigoid dyes, phosphine oxides, ketones, benzoinethers, benzilketals, alpha-dialkoxyacetophenones, alpha-hydroxyalkylphenones, alpha-aminoalkylphenones, acylphosphineoxides; and any combination or derivative thereof. Suitable inorganic photoinitiators for use in the present invention are substances that, when exposed to UV light, will generate free radicals that will interact with the microorganisms as well as other organics in a given treatment fluid. Some suitable inorganic photoinitiators include, but are not limited to, nanosized metal oxides (e.g., those that have at least one dimension that is 1 nm to 1000 nm in size) such as titanium dioxide, iron oxide, cobalt oxide, chromium oxide, magnesium oxide, aluminum oxide, copper oxide, zinc oxide, manganese oxide, and any combination or derivative thereof.

Salts may optionally be included in the treatment fluids of the present invention for many purposes, including, for reasons related to compatibility of the treatment fluid with the formation and formation fluids. To determine whether a salt may be beneficially used for compatibility purposes, a compatibility test may be performed to identify potential compatibility problems. From such tests, one of ordinary skill in the art with the benefit of this disclosure will be able to determine whether a salt should be included in a treatment fluid of the present invention. Suitable salts include, but are not limited to, calcium chloride, sodium chloride, magnesium chloride, potassium chloride, sodium bromide, potassium bromide, ammonium chloride, sodium formate, potassium formate, cesium formate, mixtures thereof, and the like. The amount of salt that should be added should be the amount necessary for formation compatibility, such as stability of clay minerals, taking into consideration the crystallization temperature of the brine, e.g., the temperature at which the salt precipitates from the brine as the temperature drops.

Examples of suitable pH control additives that may optionally be included in the treatment fluids of the present invention are bases and/or acid compositions. A pH control additive may be necessary to maintain the pH of the treatment fluid at a desired level, e.g., to improve the effectiveness of certain breakers and to reduce corrosion on any metal present in the well bore or formation, etc. In some instances, it may be beneficial to maintain the pH at 3.5-5. One of ordinary skill in the art with the benefit of this disclosure will be able to recognize a suitable pH for a particular application.

The pH control additive also may comprise a base to elevate the pH of the treatment fluid. Generally, a base may be used to elevate the pH of the mixture. Any known base that is compatible with the zirconium crosslinked-CMC of the present invention can be used in the treatment fluids of the present invention. Examples of suitable bases include, but are not limited to, sodium hydroxide, potassium carbonate, potassium hydroxide, sodium carbonate, and sodium bicarbonate. One of ordinary skill in the art with the benefit of this disclosure will recognize the suitable bases that may be used to achieve a desired pH elevation.

In some embodiments, the treatment fluids of the present invention may include surfactants, e.g., to improve the compatibility of the treatment fluids of the present invention with other fluids (like any formation fluids) that may be present in the well bore. One of ordinary skill in the art with the benefit of this disclosure will be able to identify the type of surfactant as well as the appropriate concentration of surfactant to be used. Suitable surfactants may be used in a liquid or powder form. Where used, the surfactants may be present in the treatment fluid in an amount sufficient to prevent incompatibility with formation fluids, other treatment fluids, or well bore fluids. In an embodiment where liquid surfactants are used, the surfactants are generally present in an amount in the range of from about 0.01% to about 5.0% by volume of the treatment fluid. In one embodiment, the liquid surfactants are present in an amount in the range of from about 0.1% to about 2.0% by volume of the treatment fluid. In embodiments where powdered surfactants are used, the surfactants may be present in an amount in the range of from about 0.001% to about 0.5% by weight of the treatment fluid.

In some embodiments, the surfactant may be a viscoelastic surfactant. These viscoelastic surfactants may be cationic, anionic, nonionic, amphoteric, or zwitterionic in nature. The viscoelastic surfactants may comprise any number of different compounds, including methyl ester sulfonates (e.g., as described in U.S. Patent Application Nos. 2006/0180310, 2006/0180309, 2006/0183646 and U.S. Pat. No. 7,159,659, the relevant disclosures of which are incorporated herein by reference), hydrolyzed keratin (e.g., as described in U.S. Pat. No. 6,547,871, the relevant disclosure of which is incorporated herein by reference), sulfosuccinates, taurates, amine oxides, ethoxylated amides, alkoxylated fatty acids, alkoxylated alcohols (e.g., lauryl alcohol ethoxylate, ethoxylated nonyl phenol), ethoxylated fatty amines, ethoxylated alkyl amines (e.g., cocoalkylamine ethoxylate), betaines, modified betaines, alkylamidobetaines (e.g., cocoamidopropyl betaine), quaternary ammonium compounds (e.g., trimethyltallowammonium chloride, trimethylcocoammonium chloride), derivatives thereof, and combinations thereof. In certain embodiments, the surfactant may comprise a compliant surfactant such as sodium lauryl sulfate, polyoxyethylene (20) sorbitan monolaurate (commonly known as Polysorbate 20 or Tween 20), polysorbate 60 polysorbate 65, polysorbate 80, or sorbitan monosterate.

It should be noted that, in some embodiments, it might be beneficial to add a surfactant to a treatment fluid of the present invention as that fluid is being pumped down hole to help eliminate the possibility of foaming. However, in those embodiments where it is desirable to foam the treatment fluids of the present invention, surfactants such as HY-CLEAN(HC-2) surface-active suspending agent or AQF-2 additive, both commercially available from Halliburton Energy Services, Inc., of Duncan, Okla., may be used. Additional examples of foaming agents that may be used to foam and stabilize the treatment fluids of this invention include, but are not limited to, betaines, amine oxides, methyl ester sulfonates, alkylamidobetaines such as cocoamidopropyl betaine, alpha-olefin sulfonate, trimethyltallowammonium chloride, C₈ to C₂₂ alkylethoxylate sulfate and trimethylcocoammonium chloride. Other suitable foaming agents and foam stabilizing agents may be included as well, which will be known to those skilled in the art with the benefit of this disclosure.

The methods and treatment fluids of the present invention may be used during or in preparation for any subterranean operation wherein a fluid may be used. Suitable subterranean operations may include, but are not limited to, drilling operations, fracturing operations, sand control treatments (e.g., gravel packing), acidizing treatments (e.g., matrix acidizing, fracture acidizing, removal of filter cakes and fluid loss pills), “frac-pack” treatments, well bore clean-out treatments, and other suitable operations where a treatment fluid of the present invention may be useful. One of ordinary skill in the art, with the benefit of the present disclosure, will recognize suitable operations in which the treatment fluids of the present invention may be used.

To facilitate a better understanding of the present invention, the following examples of preferred or representative embodiments are given. In no way should the following examples be read to limit, or to define, the scope of the invention.

### Example 1

General procedure for preparation of CMC based pill: To check the suitability of CMC as a fluid loss control pill a 120 lb/Mgal of CMC gel in tap water was prepared (Table 1). To a Waring Blender was added 1000 mL of tap water slowly adding carboxymethylcellulose (FDP S951-09(Halliburton product) (14.4 g) with stirring to prepare 120 lb/Mgal gel. The gel was allowed to hydrate for 30 minutes. The pH of all the 10 pills was adjusted to about 6 (Pill 1 to pill 4 and pill 6 to pill 9). 100 mL of the hydrated gel was placed in a jar and an appropriate amount of crosslinker (zirconium-based crosslinker CL-23 (Halliburton product) for pill 1 to pill 4 or Aluminum-based crosslinker FDP S961-09 (Halliburton product) for pill 6 to 9) was added. The material was transferred to a glass jar and kept in the water bath maintained at 180° F. After 30 minutes in the bath a marble was placed on top of the gel. The position of marble was measured from the upper surface periodically until the marble dropped down to bottom of the jar. The position of the marble was used as an indication of the stability of the gel. The results of the test are shown in Table 2. The zirconium-based CL-23 crosslinker formed a more stable gel (pill 1 to 4) than the aluminum crosslinker (pill 6 to pill 9).

To test the gel stability in the presence of salt, pill 5 and pill 10 were made in the presence of 2 grams of CaCl₂ (Table 1). Pill 5 was made with the same amount of zirconium-based crosslinker as pill 3. Pill 5 shows better gel stability at temperature than pill 3. Pill 10 was made with the same amount of aluminum-based crosslinker as pill 9. Pill 10 shows less gel strength initially and it is less stable at temperature as well. This indicates that the gel crosslinked with zirconium-based crosslinker CL-23 has better salt tolerance than the gel crosslinked with aluminum-based crosslinker.

TABLE 1
120 lb/Mgal CMC pill crosslinked with CL-23 and FDP S961-09

| | | | | | | | | | | Pill |
|---|---|---|---|---|---|---|---|---|---|---|
| Component | Pill 1 | Pill 2 | Pill 3 | Pill 4 | Pill 5 | Pill 6 | Pill 7 | Pill 8 | Pill 9 | 10 |
| CMC gel | 100 mL | 100 mL | 100 mL | 100 mL | 100 mL | 100 mL | 100 mL | 100 mL | 100 mL | 100 mL |
| CL-23 | 0.4 mL | 0.5 mL | 0.6 mL | 0.7 mL | 0.6 mL | — | — | — | — | — |
| FDP S961- | — | — | — | — | — | 0.42 mL | 0.62 mL | 0.72 mL | 0.84 mL | 0.84 mL |
| 09 | | | | | | | | | | |
| CaCl₂ | — | — | — | — | 2.0 g | — | — | — | — | 2.0 g |
| pH after | 5.87 | 5.9 | 5.9 | 5.95 | 5.45 | 4.51 | 4.11 | 4.12 | 4.0 | 3.59 |
| crosslink | | | | | | | | | | |

TABLE 2
Stability of 120 lb/Mgal CMC crosslinked with CL-23 and FDP
S961-09 at 180° F.

| | | | | | | | | | | Pill |
|---|---|---|---|---|---|---|---|---|---|---|
| Component | Pill 1 | Pill 2 | Pill 3 | Pill 4 | Pill 5 | Pill 6 | Pill 7 | Pill 8 | Pill 9 | 10 |
| At I hour | 50% | 75% | 90% | 90% | 90% | Weak | 5% | 70% | 70% | 10% |
| | MAS* | MAS | MAS | MAS | MAS | gel | MBS | MAS | MAS | MAS |
| At 3 hours | 5% | 20% | 50% | 60% | 90% | — | — | — | — | 5% |
| | MBS | MAS | MAS | MAS | MAS | | | | | MAS |
| At 7 hours | 5% | 20% | 50% | 60% | 90% | — | — | — | — | 50% |
| | MBS | MAS | MAS | MAS | MAS | | | | | MAS |
| At 18 | — | — | — | — | — | MAB | 60% | 10% | 10% | — |
| hours | | | | | | | MBS | MAS | MAS | |
| At 24 | 25% | 5% | 5% | 10% | 10% | MAB | 60% | 10% | 10% | MAB |
| hours | MBS | MBS | MBS | MAS | MAS | | MBS | MAS | MAS | |
| At 40 | — | — | — | — | — | MAB | MAB | MAB | MAB | MAB |
| hours | | | | | | | | | | |
| At 72 | MAB | 40% | 5% | 5% | 5% | | | | | |
| hours | | MBS | MBS | MBS | MBS | | | | | |
| At 96 | MAB | 50% | 25% | 15% | 5% | | | | | |
| hours | | MBS | MBS | MBS | MBS | | | | | |
| At 120 | MAB | MAB | 60% | 50% | 5% | | | | | |
| hours | | | MBS | MBS | MBS | | | | | |
| At 168 | MAB | MAB | 90% | 80% | 5% | | | | | |
| hours | | | MBS | MBS | MBS | | | | | |
| At 264 | MAB | MAB | MAB | MAB | 30% | | | | | |
| hours | | | | | MBS | | | | | |

*MAS = Marble above surface
† MBS = Marble below surface
‡ MAB = Marble at bottom

### Example 2

In another experiment, a weighted CMC pill with sodium bromide was prepared. CMC gel (120 lb/Mgal) was prepared in tap water and, after hydrating the gel, enough NaBr (276 in 1000 mL aqueous gel) salt was added to the gel to make approximately 10 lb/gal density pill. Then pH of the gel was adjusted to 5.9 with HCl and the gel was crosslinked with an appropriate amount of CL-23, as indicated in Table 3. The material was transferred to a glass jar and kept in the water bath maintained at 180° F. After 30 minutes a marble was placed on top of each of the pills. The position of the marble was observed to check the stability of the gel. The results of the test are shown in Table 4. It appeared that most of the pills are stable at 180° F. with various amounts of crosslinker.

TABLE 3
120 lb/Mgal CMC pill crosslinked with CL-23
containing NaBr brine (density ~10 lb/gal)

| Component | Pill 11 | Pill 12 | Pill 13 | Pill 14 |
|---|---|---|---|---|
| CMC gel | 100 mL | 100 mL | 100 mL | 100 mL |
| CL-23 | 0.5 mL | 0.6 mL | 0.7 mL | 0.8 mL |
| pH to | 5.54 | 5.56 | 5.59 | 5.57 |
| crosslink | | | | |

TABLE 4
Stability of 120 lb/Mgal CMC pill crosslinked with CL-23 containing
NaBr brine (density ~10 lb/gal) at 180° F.

| Component | Pill 11 | Pill 12 | Pill 13 | Pill 14 |
|---|---|---|---|---|
| At 1 hour | 90% MAS | 95% MAS | 100% MAS | 100% MAS |
| At 29 hours | 20% MAS | 30% MAS | 30% MAS | 50% MAS |
| At 49 hours | 20% MAS | 25% MAS | 20% MAS | 50% MAS |
| At 72 hours | 20% MAS | 25% MAS | 20% MAS | 50% MAS |
| At 96 hours | 5% MAS | 5% MAS | 5% MAS | 20% MAS |

* MAS = Marble above surface
† MBS = Marble below surface
‡ MAB = Marble at bottom

### Example 3

In another experiment, a weighted 120 lb/Mgal CMC pill with zinc bromide was prepared. 7.2 g of CMC was first blended with 12 mL of glycerol to make a paste. This operation help prevent “fish eyes” when hydrating CMC in water. 96 mL of water was added to the CMC/glycerol paste in a Waring Blender and shear for 5 min. 392 mL of 19.2 lb/gal ZnBr₂ brine was then slowly added to make a 16.9 lb/gal fluid. The solution was sheared for 15 minutes then left at room temperature for one hour. Then pH of the gel was adjusted to 5.9 with HCl and the gel was crosslinked with an appropriate amount of CL-23, as indicated in Table 5 (pill 15 to pill 18). The material was transferred to a glass jar and kept in the water bath maintained at 180° F. After 30 minutes a marble was placed on top of each of the pills. The position of the marble was observed to check the stability of the gel. The results of the test (pill 15 to pill 18) are shown in Table 6. Pill 17 is stable for at least 25 hours at 180° F. and break on its own within 41 hours without any internal breaker. Pill 18 was stable for at least 44 hours at 180° F. The preparation of a gel in zinc bromide is important as at higher pH the salt precipitate out. This system demonstrates the ability operate at low pH precipitate formation.

TABLE 5
120 lb/Mgal CMC pill crosslinked with CL-23
containing ZnBr₂ brine (density ~16.9 lb/gal)

| Component | Pill 15 | Pill 16 | Pill 17 | Pill 18 |
|---|---|---|---|---|
| CMC gel | 100 mL | 100 mL | 100 mL | 100 mL |
| CL-23 | 0.9 mL | 1.1 mL | 1.3 mL | 1.5 mL |

TABLE 6
Stability of 120 lb/Mgal CMC pill crosslinked with CL-23 containing
ZnBr₂ brine (density ~16.9 lb/gal) at 180° F.

| Component | Pill 15 | Pill 16 | Pill 17 | Pill 18 |
|---|---|---|---|---|
| At 1 hour | 30% MAS | 30% MAS | 30% MAS | 60% MAS |
| At 2 hours | 30% MAS | 30% MAS | 30% MAS | 50% MAS |
| At 8 hours | 30% MAS | 35% MAS | 30% MAS | 50% MAS |
| At 17 hours | 30% MBS | 5% MAS | 10% MAS | 20% MAS |
| At 25 hours | MAB | MAB | 30% MBS | 10% MAS |
| At 41 hours | All gel | All gel | All gel | 10% MAS |
| | broken | broken | broken | |
| At 44 hours | — | — | — | 30% MBS |

* MAS = Marble above surface
† MBS = Marble below surface
‡ MAB = Marble at bottom

### Example 4

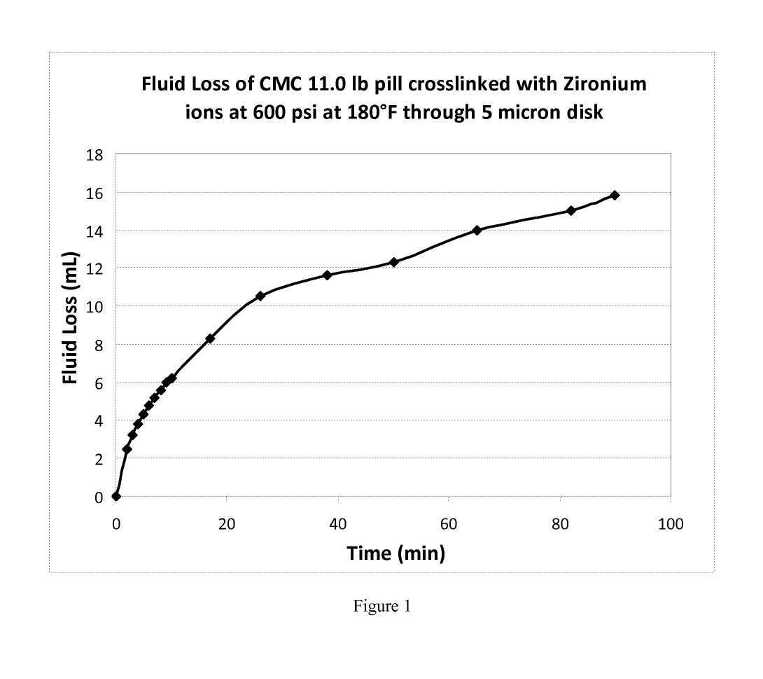

Conductivity Test: A conductivity test was run on 11.00 lb zirconium crosslinked CMC fluid (120 lb/Mgal) in a high pressure, high temperature (HPHT) cell using 5 micron Alloxite disc, at 180° F. and a pressure of 600 psi. The fluid loss was measure and the results are shown in FIG. 1. Initial permeability of the disc was 1.32 d and the final permeability was 1.1 d. The regained permeability was 83% of the initial value.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

The invention claimed is:

1. A method comprising:
providing a treatment fluid comprising carboxymethylcellulose (CMC) and a crosslinker comprising zirconium;
wherein the carboxymethylcellulose has a degree of substitution in a range of from about 0.5 to about 2.5;
wherein the crosslinker comprising zirconium comprises one selected from the group consisting of ammonium zirconium fluoride, zirconium 2-ethylhexanoate, zirconium acetate, zirconium neodecanoate, zirconium acetylacetonate, tetrakis(triethanolamine) zirconate, zirconium carbonate, ammonium zirconium carbonate, zirconyl ammonium carbonate, zirconium complex of hydroxyethyl glycine, zirconium malonate, zirconium propionate, zirconium lactate, zirconium acetate lactate, and zirconium tartrate; and
placing the treatment fluid in a subterranean formation,
wherein the treatment fluid controls fluid loss in a permeable portion of the subterranean formation penetrated by a wellbore.

2. The method of claim 1, wherein the treatment fluid has a pH in a range of from about 4 to about 7.

3. The method of claim 1, wherein the treatment fluid is weighted with a brine solution.

4. The method of claim 3, where the brine solution comprises one selected from the group consisting of sodium chloride, potassium chloride, ammonium chloride, sodium bromide, potassium bromide, zinc bromide, sodium formate, potassium formate, cerium formate, calcium chloride, and combinations thereof.

5. The method of claim 3, wherein the treatment fluid has a density in a range of from about 8.33 lb/gal to about 14.0 lb/gal.

6. A method comprising:
providing a treatment fluid comprising a crosslinked gel, the crosslinked gel comprising carboxymethylcellulose and a crosslinker comprising zirconium;
wherein the crosslinker comprising zirconium comprises one selected from the group consisting of ammonium zirconium fluoride, zirconium 2-ethylhexanoate, zirconium acetate, zirconium neodecanoate, zirconium acetylacetonate, tetrakis(triethanolamine) zirconate, zirconium carbonate, ammonium zirconium carbonate, zirconyl ammonium carbonate, zirconium complex of hydroxyethyl glycine, zirconium malonate, zirconium propionate, zirconium lactate, zirconium acetate lactate, and zirconium tartrate; and
shearing the crosslinked gel to provide a plurality of gel particles having an average diameter in the range of from about 0.5 mm to about 50 mm;
placing the plurality of gel particles in an aqueous fluid having a density similar to the density of the gel particles whereby a suspension of the plurality of gel particles is produced; and
placing the suspension in a permeable portion of a wellbore penetrating a subterranean formation to control fluid loss.

7. The method of claim 6, wherein the carboxymethylcellulose has a degree of substitution in a range of from about 0.5 to about 2.5.

8. The method of claim 6, wherein the treatment fluid further comprises a brine solution.

9. The method of claim 8, where the brine solution comprises one selected from the group consisting of sodium chloride, potassium chloride, ammonium chloride, sodium bromide, potassium bromide, zinc bromide, sodium formate, potassium formate, cerium formate, calcium chloride, and combinations thereof.

10. The method of claim 8, wherein the treatment fluid has a density in a range of from about 8.33 lb/gal to about 14.0 lb/gal.

11. The method of claim 7, wherein the treatment fluid has a pH in a range of from about 4 to about 7.

12. A method comprising:
providing a treatment fluid comprising a crosslinked gel, the crosslinked gel comprising carboxymethylcellulose and a crosslinker comprising zirconium;
wherein the carboxymethylcellulose has a degree of substitution in a range of from about 0.5 to about 2.5;
shearing the crosslinked gel to provide a plurality of gel particles having an average diameter in the range of from about 0.5 mm to about 50 mm;
placing the plurality of gel particles in an aqueous fluid having a density similar to the density of the gel particles whereby a suspension of the plurality of gel particles is produced; and
placing the suspension in a permeable portion of a wellbore penetrating a subterranean formation to control fluid loss.

13. The method of claim 12, wherein the crosslinker comprising zirconium comprises one selected from the group consisting of ammonium zirconium fluoride, zirconium 2-ethylhexanoate, zirconium acetate, zirconium neodecanoate, zirconium acetylacetonate, tetrakis(triethanolamine) zirconate, zirconium carbonate, ammonium zirconium carbonate, zirconyl ammonium carbonate, zirconium complex of hydroxyethyl glycine, zirconium malonate, zirconium propionate, zirconium lactate, zirconium acetate lactate, and zirconium tartrate.

14. The method of claim 12, wherein the treatment fluid further comprises a brine solution.

15. The method of claim 14, where the brine solution comprises one selected from the group consisting of sodium chloride, potassium chloride, ammonium chloride, sodium bromide, potassium bromide, zinc bromide, sodium formate, potassium formate, cerium formate, calcium chloride, and combinations thereof.

16. The method of claim 14, wherein the treatment fluid has a density in a range of from about 8.33 lb/gal to about 14.0 lb/gal.

17. The method of claim 12, wherein the treatment fluid has a pH in a range of from about 4 to about 7.
